(19) United States
(12) Patent Application Publication
(10) Pub. No.: US 2018/0265016 A1
(43) Pub. Date: Sep. 20, 2018

(54) Method for Manufacturing a Vehicle Outer Surface Component and Vehicle Outer Surface Component

(71) Applicant: Webasto SE, Stockdorf (DE)

(72) Inventors: Jan WOKÖCK, Bad Aibling (DE); Jan HAMMER, Munich (DE)

(21) Appl. No.: 15/983,248

(22) Filed: May 18, 2018

Related U.S. Application Data
(63) Continuation-in-part of application No. 15/023,861, filed on Mar. 22, 2016, now abandoned.

(30) Foreign Application Priority Data
Oct. 4, 2013 (DE) 10 2013 016 325.0

(51) Int. Cl. B60R 13/04; B32B 27/08; B32B 7/02; B32B 27/40

(52) U.S. Cl. CPC B60R 13/04; B32B 27/08; B32B 7/02; B32B 27/40; B32B 2255/10; B60J 7/00; B32B 2307/406; B32B 2307/536; B32B 2307/584; B32B 2307/71; B32B 2605/003; B32B 2255/26

(57) ABSTRACT

The invention relates to a method for producing a vehicle outer surface component (1) comprising the following steps: preparing a base component (2) made of a thermoplastic material in an injection mold by injecting a thermoplastic material into the injection mold or by placing a prefabricated base component made of a thermoplastic material therein, and injecting a covering layer (4) of a scratch self-healing plastic material into the closed injection mold to coat the base component (2); the invention further relates to a vehicle outer surface component, in particular a vehicle outer surface component produced according to this method.

### CROSS-REFERENCE TO RELATED APPLICATIONS

This application is a continuation-in-part application of U.S. application Ser. No. 15/023,861, filed on Mar. 22, 2016, which is national stage application under 35 U.S.C. § 371 of International Application No. PCT/EP2014/070956, filed Sep. 30, 2014, which claims priority from German Application No. 10 2013 016 325.0, filed Oct. 4, 2013, the entire content of each of which are hereby incorporated by reference.

The invention relates to a method for producing a vehicle outer surface component and to a vehicle outer surface component.

A vehicle outer surface component of this type may be a cover for a roof opening system, for example, such as a sunroof or a spoiler roof, or an exterior molding component of a vehicle.

DE 10 2008 064 233 A1 describes a door sill panel having an in-mold film, at least sections of which form the surface of the door sill panel and which is made of polycarbonate or a comparable plastic material. A plastic component made of a translucent plastic material is molded onto the back of the in-mold film by injection molding and can be used as a light guide for a light source. Another plastic component made of opaque plastic material is injected onto the plastic component made of translucent plastic. This additional plastic component made of opaque plastic material can form the base component for the door sill panel and can ensure that the door sill panel has sufficient rigidity to withstand the mechanical loads that will be placed on the component. In addition, the front side of the in-mold film that forms the surface portion can be provided with a hard coating of polysiloxane. However, a hard polysiloxane coating of this type is not sufficiently scratch resistant. Scratches in the plastic material cannot be easily repaired.

It is the object of the invention to provide a method for producing a vehicle outer surface component as described in the introductory part of the specification that will provide an improved vehicle outer surface component, and to provide such a vehicle outer surface component.

This object is attained according to the invention by a method for producing a vehicle outer surface component comprising the following steps:
preparing a base component made of a thermoplastic material in an injection mold by injecting a thermoplastic material into the injection mold or by placing a prefabricated base component made of a thermoplastic material therein and
injecting a covering layer of a scratch self-healing plastic material into the closed injection mold to coat the base component.

The object is further attained by a vehicle outer surface component which has a layered structure comprising at least a base layer and a covering layer, the covering layer being produced from a scratch self-healing plastic material.

Advantageous embodiments of the invention are specified in each of the dependent claims.

The method according to the invention is therefore characterized in that, for producing a vehicle outer surface component, a coating, in particular a “clear-coat” or transparent coating of a soft plastic material which is scratch self-healing is used and is injected as the covering layer. Self-healing means that when damaged, the plastic material of the covering layer is capable of healing itself or being healed to a full reversal of the damage as long as the molecular structure or the molecular network of the plastic material of the covering layer is not excessively damaged or destroyed when damaged or scratched. Such plastic materials are “soft” in the sense that they yield to damage rather than being injured or scratched—as is the case with hard materials. The restoration properties are dependent on the glass point of the material. By applying heat from external heat sources, the material temperature can be increased so as to induce a self-repair of the material. The material can also be repaired by polishing the surface.

Thus with the method according to the invention, rather than placing a finished coated film into the mold as the covering layer, the base layer prepared or produced in the injection mold is coated with the injected covering layer.

A base component made of thermoplastic material can be prepared in an injection mold either by injecting a thermoplastic material into the injection mold or by placing a prefabricated base component made of thermoplastic material therein. An emplaced base component can also be coated in the injection mold before the covering layer is injected.

The base component is particularly layered, and if it is an emplaced part, it can be a film, e.g. made of plastic or of a compound or composite material, in particular with a PU matrix or resin matrix.

It is particularly preferable for the plastic material of the covering layer to be a PUR (polyurethane) or PUA (polyurea) and particularly to be produced with a high-gloss surface. PUR and PUA have self-healing characteristics, even if the covering layer is produced as very thin, e.g. in a layer thickness of 0.1 mm to 2.0 mm.

The PUR or PUA is preferably a UV-resistant plastic material. This enables vehicle outer surface components according to the invention to be used permanently without material changes occurring as a result of UV radiation. In the case of transparent roof components, UV radiation is prevented from reaching the vehicle interior.

The properties of PUR materials can be influenced by selecting raw material components such as polyols and isocyanates, by adjusting the ratios of raw material components, and by the addition of additive compounds. Hardness is a very important characteristic of PUR materials. For scratch self-healing properties, one would preferably choose PUR materials having a Shore hardness ranging from 65 Shore A to 80 Shore D. The glass transition temperature (Tg) of useful PUR materials preferably ranges from 40 to 75° C., and even more preferably range from 40 to 60° C., dependent on the desired balance of hardness and self-healing properties. Without intending to be bound by any particular theory, it is thought that the self-healing properties depend on the reversible stretching and adjusting of the molecular network of the PUR material.

According to an expedient embodiment of the method, before the covering layer is injected an intermediate layer or functional layer can be applied to the base component in the injection mold, so that the covering layer is then applied to this intermediate layer or functional layer. This enables vehicle outer surface components according to the invention having additional functions and characteristics to be produced.

Expedient process sequences, both individually and in combinations, are preferred for producing vehicle outer surface components. For instance, the base component and/or the intermediate layer or functional layer can be formed as transparent, translucent or colored and can be formed with a smooth, grained or structured surface and/or can be formed as having text or a graphic pattern. For example, manufacturer names or logos can be introduced into a transparent intermediate layer or functional layer and then covered with a transparent, scratch-proof covering layer.

According to a preferred method variant, the base component can be produced with a structured surface and covered with a clear covering layer, so that although the surface structure is protected and covered with a smooth layer, it is still transparent. A structured surface is produced, e.g. by using a correspondingly negatively molded surface of a mold half or turnover plate mold of the injection mold. A structured surface contains, e.g. graining, a printed text or graphic applied to the base component, or an overmolded 3-D structure.

The intermediate layer or functional layer can also expediently contain at least one light guide or can be formed as a light guide layer, a design layer or a touch-sensitive layer for generating a signal, or can contain an antenna device or heating wires, or can be formed as a three-dimensional structure in at least one partial area. These configurations may also be used individually or in combination.

Finally, the covering layer may also be colorized if transparency is not required and a colored design is desired instead.

A vehicle outer surface component according to the invention is produced in particular according to a method as described above or according to any one of claims 9 to 14. For instance, in the vehicle outer surface component, the functional layer can be a light guide layer or can at least contain a light guide, can be a design layer or a touch-sensitive layer for generating a signal, or can contain an antenna device or heating wires.

The vehicle outer surface component can be, e.g. pillar molding, a door sill panel or a fixed or movable, particularly a transparent cover for a roof module.

In the following, the invention will be specified in greater detail in the context of embodiment examples of a vehicle outer surface component according to the invention, with reference to the set of drawings. The drawings show:

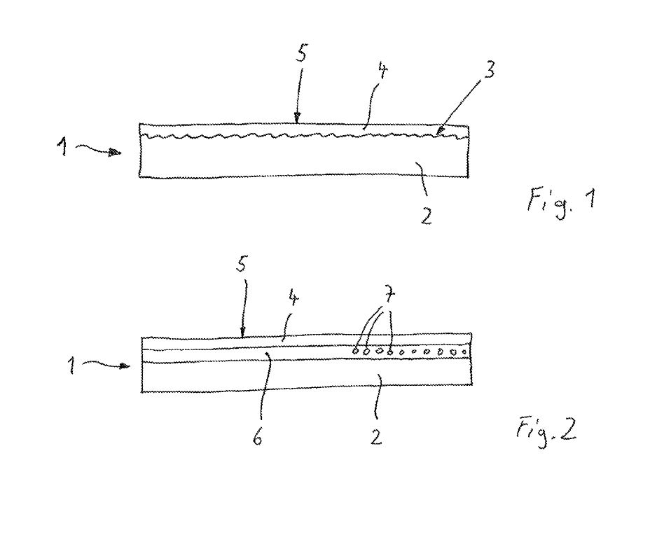

FIG. 1 a sectional view of a vehicle outer surface component according to the invention; and

FIG. 2 a sectional view of another vehicle outer surface component.

FIG. 1 shows a schematic sectional representation of a vehicle outer surface component 1, e.g. in the form of a cover for a roof module. A base layer 2 made of a thermoplastic material is formed with a structured upper side 3 or surface. Base layer 2 is coated with a covering layer 4 which is made of a self-healing plastic, e.g. PUR or PUA, and particularly comprises clear plastic, so that structured upper side 3 is transparent. Surface 5 of covering layer 4 may be formed as smooth and high-gloss or also as structured.

A vehicle outer surface component 1 as shown in FIG. 2 contains, on base layer 2, an intermediate layer or functional layer 6, onto which covering layer 4 is applied. Intermediate layer or functional layer 6 contains, e.g. heating wires 7 of a heating device.

The individual features of the invention disclosed in the description in the context of the embodiment examples and in the figures may be combined in any technically expedient arrangements and configurations with the subject matter of the invention in its general form.

### LIST OF REFERENCE SIGNS

1 vehicle outer surface component

2 base layer

3 structured upper side

4 covering layer

5 surface

6 intermediate layer or functional layer

7 heating wire

1. A method for producing a vehicle outer surface component, comprising:
preparing a base component made of a thermoplastic material in an injection mold by injecting a thermoplastic material into the injection mold or by placing a prefabricated base component made of a thermoplastic material therein and
injecting a covering layer of a material formed dependent on a glass point to provide a scratch self-healing plastic into the closed injection mold to coat the base component.

2. The method according to claim 1, wherein the step of injecting a covering layer is by injecting a PUR (polyurethane) or PUA (polyurea) having a high-gloss surface.

3. The method according to claim 1, wherein the PUR or PUA is a UV-resistant plastic material.

4. The method according to claim 1, wherein before the step of injecting the covering layer, includes the step of applying an intermediate layer or a functional layer to the base component in the injection mold, and applying the covering layer to the intermediate layer or functional layer.

5. The method according to claim 4, further including forming the base component and/or the intermediate layer or functional layer as transparent, translucent or colored and/or forming as having a smooth, grained or structured surface and/or forming as having text or a graphic pattern.

6. The method according to claim 1, further including producing the base component as a structured surface and the covering layer is clear.

7. The method according to claim 4, wherein the intermediate layer or functional layer contains at least one light guide or is formed as a light guide layer, is a design layer or a touch-sensitive layer for generating a signal, or contains an antenna device or heating wires, or is formed at least in a partial area as a three-dimensional structure.

8. The method according to claim 1, further comprising the step of colorizing the covering layer.

9. A vehicle outer surface component, comprising: at least a base layer made of a thermoplastic material and a covering layer, wherein the covering layer is produced from a material formed dependent on a glass point to provide a scratch self-healing plastic.

10. The vehicle outer surface component according to claim 9, wherein the covering layer is produced from PUR (polyurethane) or PUA (polyurea) and has a high-gloss surface and/or is UV-resistant.

11. The vehicle outer surface component according to claim 9, wherein an intermediate layer or functional layer is positioned between the base layer and the covering layer.

12. The vehicle outer surface component according to claim 9, wherein the covering layer is applied as an injection molded layer onto the base layer or the intermediate layer or functional layer in an injection mold.

13. The vehicle outer surface component according to claim 9, wherein a functional layer is a light guide layer or at least contains a light guide, is a design layer or a touch-sensitive layer for generating a signal, or contains an antenna device or heating wires.

14. The vehicle outer surface component according to claim 9, wherein the component is a pillar molding or a door sill panel.

15. The vehicle outer surface component according to claim 9, produced by the method according to claim 1.

16. The vehicle outer surface component according to claim 9, wherein the component is a fixed or movable cover for a roof module.

17. The vehicle outer surface component according to claim 9, wherein the component is transparent.

18. The method according to claim 1, wherein the step of injecting a covering layer is by injecting a PUR (polyurethane) having a Shore hardness ranging from 65 Shore A to 80 Shore D.

19. The method according to claim 1, wherein the step of injecting a covering layer is by injecting a PUR (polyurethane) having a glass transition temperature (Tg) ranging from 40 to 60° C.

20. The vehicle outer surface component according to claim 9, wherein the covering layer is produced from PUR (polyurethane) having a Shore hardness ranging from 65 Shore A to 80 Shore D.

21. The vehicle outer surface component according to claim 9, wherein the covering layer is produced from PUR (polyurethane) having a glass transition temperature (Tg) ranging from 40 to 60° C.
